(19) United States
(12) Patent Application Publication
(10) Pub. No.: US 2025/0222807 A1
(43) Pub. Date: Jul. 10, 2025

(54) SYSTEM AND METHOD FOR CONTROLLING A VEHICLE BATTERY PACK BASED ON OPEN CIRCUIT VOLTAGE

(71) Applicant: Ford Global Technologies, LLC, Dearborn, MI (US)

(72) Inventors: Richard Dyche Anderson, Plymouth, MI (US); Christian Edward Shaffer, Canton, MI (US)

(21) Appl. No.: 18/405,357

(22) Filed: Jan. 5, 2024

(51) Int. Cl. B60L 53/62; B60L 50/60; B60L 58/12; B60L 58/16

(52) U.S. Cl. CPC B60L 53/62; B60L 50/66; B60L 58/12; B60L 58/16; B60L 2240/547; B60L 2260/44

(57) ABSTRACT

An electrified vehicle (EV) includes a battery pack, one or more sensors, and a vehicle controller. The battery pack includes a plurality of battery cells and is operable to provide at least a portion of propulsion power of the EV. The vehicle controller is configured to charge and discharge the battery pack according to power limits defined at activation of the EV by an estimated open circuit voltage (OCV) for each of the battery cells that is based on voltages measured by the one or more sensors after a last deactivation of the EV and a decay parameter that is a function of the voltages and a duration since the last deactivation.

### TECHNICAL FIELD

The present disclosure generally relates to managing and/or controlling a battery pack for an electrified vehicle.

### BACKGROUND

An electrified vehicle (EV) includes a battery pack, sometimes referred to as a traction battery, for providing power to electric motors to propel the EV. One or more operational characteristics of the battery pack, such as power limits and state of charge (SOC), may be estimated to control the charge and discharge operation of the battery pack.

In a non-limiting example, the EV includes a battery management module (BMM) and a control system. Generally, during a discharge operation (e.g., driving of the EV), the BMM is configured to estimate SOC and/or power limits of the battery pack, and the control system is configured to control various devices/subsystems within the EV by, for example, determining how much power can be drawn from the battery pack using the operational characteristics, inputs from a user, power demand of devices (e.g., motors, air condition system, etc.), and/or among other information. For a charge operation, the BMM is configured to provide a charge current/voltage request to the control system, which in return controls the EV to begin charging the battery pack (e.g., control an electric vehicle supply equipment (EVSE)).

### SUMMARY

In one form, the present disclosure is directed to an electrified vehicle (EV) including a battery pack, one or more sensors, and a vehicle controller. The battery pack includes a plurality of battery cells and is operable to provide at least a portion of propulsion power of the EV. The vehicle controller is configured to charge and discharge the battery pack according to power limits defined at activation of the EV by an estimated open circuit voltage (OCV) for each of the battery cells that is based on voltages measured by the one or more sensors after a last deactivation of the EV and a decay parameter that is a function of the voltages and a duration since the last deactivation.

In one form, the present disclosure is directed to a method of controlling an electrified vehicle (EV) having a battery pack including a plurality of battery cells. The method includes, responsive to a deactivation request, opening one or more contactors to electrically decouple the battery pack from a charge-discharge system of the EV; and responsive to an activation, closing the one or more contactors to electrically couple the battery pack to the charge-discharge system and charging or discharging the battery pack according to power limits defined at the activation of the EV by an estimated open circuit voltage (OCV) for each of the battery cells that is based on voltages measured by the one or more sensors after a last deactivation of the EV and a decay parameter that is a function of the voltages and a duration since the last deactivation.

In one form, the present disclosure is directed to a system for an electrified vehicle (EV) including a battery pack having a plurality of battery cells and operable to provide at least a portion of propulsion power of the EV. The system includes a controller configured to charge and discharge the battery pack according to a state of charge that is initially defined at activation of the EV by an estimated open circuit voltage (OCV) for each of the battery cells. The estimated OCV is based on voltages measured by one or more sensors of the EV after a last deactivation of the EV and a decay parameter that is a function of the voltages and a duration since the last deactivation. The decay parameter includes an exponential parameter involving a square root of the duration, and the duration is less than an equilibrium time for active material of each of the battery cells to equally distribute across an electrode of the battery cell.

### BRIEF DESCRIPTION OF THE DRAWINGS

FIG. 1 is an example block diagram of an electrified vehicle (EV) in accordance with the present disclosure;

FIG. 2 is a block diagram of a battery pack of the EV in accordance with the present disclosure;

FIG. 3 is a block diagram of a battery management module of the EV in accordance with the present disclosure;

FIG. 4 is a graph illustrating an example relationship between voltage and time after the battery pack is disconnected from a charge-discharge system of the EV in accordance with the present disclosure; and

FIG. 5 is a flowchart of an example battery pack control routine in accordance with the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Generally, to manage a battery pack in an electrified vehicle (EV), a vehicle system of the EV needs to know a state of charge (SOC) of the battery pack to estimate the power capability/power limit of the battery pack. For most battery chemistries, the SOC is estimated based on an open circuit voltage (OCV) of the battery pack, which is the voltage of the battery pack at rest. In a non-limiting example, for hybrid electric vehicles (HEV), with the sizes of the battery cells typically on the order of five (5) ampere-hours, the OCV may stabilize within 30 minutes, but may take longer at colder temperatures. Specifically, stabilization is when the active material equally distributes (through diffusion) across the thickness of an electrode, and the time it takes to reach stabilization may be referred to as equilibrium time for the battery cell. Battery charge and discharge reactions occur at the electrode surface. As battery cells get bigger, the electrodes tend to get thicker and thus, the equilibrium time increases. Some battery cells for EVs may require a few hours (e.g., over 3 hours) for the OCV to stabilize, which is longer at cold temperatures.

In various situations, it may be difficult for the EV to rest (i.e., no charging or discharging) for such long equilibrium times. For example, in one situation, a user of the EV may stop at a restaurant for a meal, which may only take one to two hours. In another example, the user may stop at a charging station, and the amount of time it takes between turning the EV off to charging the battery pack may be mere minutes.

Furthermore, the number of battery cells employed in the battery pack of the EV may also influence the detection of the OCV, which is measured for each battery cell. Specifically, some EVs have about 96 cells in series, and with the EV moving towards higher electric power systems (e.g., 800V to 1200V) the number of battery cells may double or even triple, thereby increasing computational requirements of the vehicle system.

New EV battery warranty protocols may also require the EV to detect a state of certified energy” (SOCE) or state of health (SOH), which is the amount of energy a battery pack can deliver for standard drive cycles relative to that when the battery pack was new. Accordingly, the SOC at rest derived from the OCV must be accurate in order to obtain a good estimate of capacity decay. Specifically, some regulations call for an energy estimate within 5% of actual, calling for the SOC to be within 2% or less in order to calculate an “accurate enough” capacity and therefore, energy.

The present disclosure is generally directed to a vehicle system configured to charge/discharge a battery pack based on an estimated OCV. Specifically, the OCV is estimated for each battery cell using voltage measurements and a decay parameter that is a function of the voltages since a last deactivation of the battery pack. With the estimated OCV, the vehicle system can estimate a SOC, provide an available energy at the beginning of a drive cycle which is used to predict a vehicle drive range, and/or provide a power limit estimation, among other actions (e.g., output a SOH). As described in detail herein, the OCV may be estimated within a fraction of the time required for the battery cells to obtain equilibrium, and therefore, accuracy of the SOC and thus, accuracy of the power limit may be improved. Specifically, power limits can change rapidly, the OCV is used to ensure a more accurate power limit when the vehicle starts. During the drive/charge cycle, the EV operates the vehicle using power limits estimated using other factors than OCV.

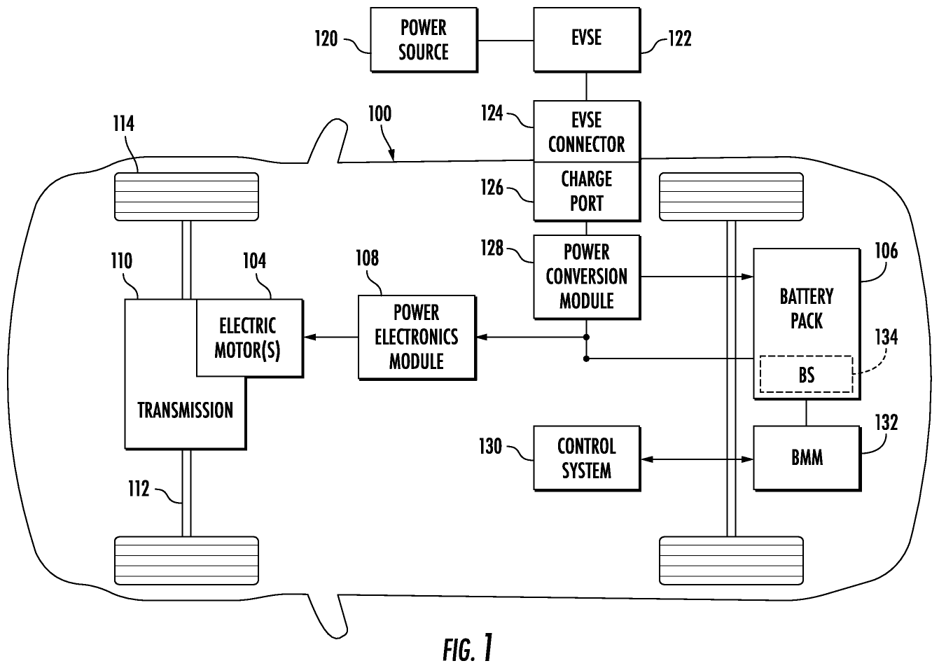

Referring to FIGS. 1 and 2, in one form, an EV 100 is provided as a fully battery electric vehicle (BEV) powered by electric motors. In a non-limiting example, the EV 100 includes a powertrain system having one or more electric motors 104 (i.e., electric machines), a battery pack 106 (i.e., a traction battery), and a power electronics module 108. The EV 100 of the present disclosure does not include an engine, and thus, the battery pack 106 provides all of the propulsion power. In other variations, the present disclosure may be applied to other types of EVs such as a hybrid electric vehicle (plug-in or non-plug-in) having an engine, fuel cell electric vehicles (FCEV) and is not limited to pure battery powered EVs. In addition, the EV is not limited to four-wheel automobiles and may apply to scooters, three-wheel vehicles, aerial vehicles, and/or among other vehicles.

The electric motor 104 provides power movement of the EV 100, and in a non-limiting example, is mechanically connected to a transmission 110 that is mechanically connected to a drive shaft 112, which is mechanically connected to wheels 114 of the EV 100. In addition to providing propulsion power, the electric motor 104 may be configured to operate as a generator to recover energy that may normally be lost as heat in a friction braking system of EV 100.

The battery pack 106 provides a high-voltage (HV) direct current (DC) output that is employed to power the electric motor 104 via the power electronics module 108, and while one battery pack 106 is shown, the EV 100 may include multiple battery packs. In one form, the power electronics module 108, which includes an inverter, provides a bidirectional transfer energy between the battery pack 106 and the electric motor 104. Specifically, as known, the power electronics module 108 converts the DC voltage to a three-phase AC current to operate the electric motor 104, and in a regenerative mode, the power electronics module 108 converts three-phase AC current from the electric motor 104, which is acting as a generator, to DC voltage compatible with the battery pack 106.

The battery pack 106 may be rechargeable by an external power source 120 (e.g., the grid), which is electrically connected to an electric vehicle supply equipment (EVSE) 122. The EVSE 122 provides circuitry and controls to manage the transfer of electrical energy between the external power source 120 and the EV 100. The external power source 120 may provide DC or AC electric power to the EVSE 122. The EVSE 122 may have a charge connector 124 for plugging into a charge port 126 of the EV 100.

The EV 100 may further include a power conversion module 228 that is an on-board charger having a DC/DC converter to condition power supplied from the EVSE 222 and provide the proper voltage and current levels to the battery pack 106. The power conversion module 228 may interface with the EVSE 222 to coordinate the delivery of power to the battery pack 106.

In addition to providing electrical energy for propulsion, the battery pack 106 may provide electrical energy for use by other electrical systems in the EV 100 such as HV loads like electric heater and air-conditioner systems, and low-voltage (LV) loads like an auxiliary battery. In some variations, the battery pack 106 is configured to have bidirectional power transfer capability to provide power to systems outside of the EV 100 (i.e., external system) such as, but not limited to, home, business, and/or a microgrid. In a non-limiting example, the battery pack 106 is electrically coupled to the external system using the EVSE connector 224 and is operable to provide energy based on a transient load recommended for the external system and an amount of energy available from the battery pack 106.

In one form, the EV 100 includes a control system 130 to coordinate the operation of the various components. The control system 130 includes electronics, software, or both, to perform the necessary control functions for operating the EV 100. The control system 130 may be a combination vehicle control system and powertrain control module (VSC/PCM). Although the control system 130 is shown as a single device, the control system 130 may include multiple controllers in the form of multiple hardware devices, or multiple software controllers with one or more hardware devices. In this regard, a reference to a “controller” herein may refer to one or more controllers.

In one form, the EV 100 includes a battery management module (BMM) 132 configured to estimate one or more operating characteristics of the battery pack 106 and provide one or more of the operating characteristics to the control system 130, which, using known techniques, control operation of the battery pack 106 (e.g., control charging/discharging of the battery pack 106). In a non-limiting example, during drive operation, the BMM 132 provides operational characteristics such as, but not limited to, power limit and/or SOC, to the control system 130, which determines how much power to draw from the battery pack 106. During a charge operation, the BMM 132 notifies the control system 130 of how much power is needed to charge the battery pack 106. The BMM 132 forms part of the vehicle control system with the control system 130 and while illustrated separate from the control system 130, may be integrated with the control system 130. In one form, the BMM 132 and the control system 130 may be referred to as a vehicle controller.

In one form, the BMM 132 is in communication with one or more sensors 134 provided with the battery pack 106 to estimate characteristics of the battery pack 106, such as but not limited to, electric current, voltage, and/or temperature.

Among other components, the battery pack 106 includes multiple battery arrays 202A and 202B (collectively “arrays 202”), where each array 202 includes a plurality of battery cells 204-1 to 204N (collectively “cells 204”) connected in series (FIG. 2). The arrays 202 are connected to a positive power bus 206A and a negative power bus 206B (collectively “power buses 206”). While two arrays 202 are provided, the battery pack 106 may include one or more arrays 202, and should not be limited to the example provided herein. In addition, the arrays 202 and/or cells 204 of the battery pack 106 may be configured in various suitable ways. In a non-limiting example, the battery pack 106 may be configured to have the arrays 202 in series, and for each array 202, the cells 204 are provided in parallel.

The sensors 134 includes one or more sensors 134A and 134B for the arrays 202. In one form, the sensors 134 include voltage sensors and current sensors for measuring voltage and/or electric current of the array 202 and in some variations, of each battery cell 204. It should be readily understood that the sensors 134 may include other sensors, such as but not limited to, temperature sensors for measuring a temperature of the array 202 and/or the battery pack 106.

In one form, one or more contactors 210 are provided to inhibit or permit electric current from traveling through the power buses 206 to/from the battery pack 106. Specifically, the contactors 210 are operable to electrically decouple or couple the battery pack 106 from/to a charge-discharge system of the EV 100. The charge-discharge system of the EV includes components that either charge the battery pack 106 or act as a load to draw electric power from the battery pack 106, and thus, may include the charge port 126, the power electronics module 108, and/or the transmission 110, among other components. The contactors 210 may be placed in various suitable position in the EV 100, such as, but not limited to, between the positive power bus 206A and the power electronics module 108. In a non-limiting example, the contactor 210 may be provided as a relay or electromechanical switch.

In one form, the BMM 132 is configured to open or close the contactors 210 based on a message/request from the control system 130. In a non-limiting example, the control system 130 is configured to detect when the EV 100 is to be turned ON or OFF based on an activation input (e.g., a user pressing a button associated with activating/deactivating the EV 100). If the EV 100 is to be turned ON, the control system 130 provides an activation request to the BMM 132 to close the contactors 210, thereby electrically coupling the battery pack 106 to the charge-discharge system of the EV 100. If the EV 100 is to be turned OFF, the control system 130 provides a deactivation request to the BMM 132 to open the contactors 210, thereby electrically coupling the battery pack 106 to the charge-discharge system of the EV 100. In addition, the control system 130 is configured to have the BMM 132 close the contactor 210 by sending the activation request when the battery pack 106 is to be charged, which may be detected by a sensor at the charge port (e.g., a sensor indicating the EVSE 122 is connected to the charge port 126, a sensor for detecting a charge port door (not shown) opening, and/or among other suitable charge detection methods).

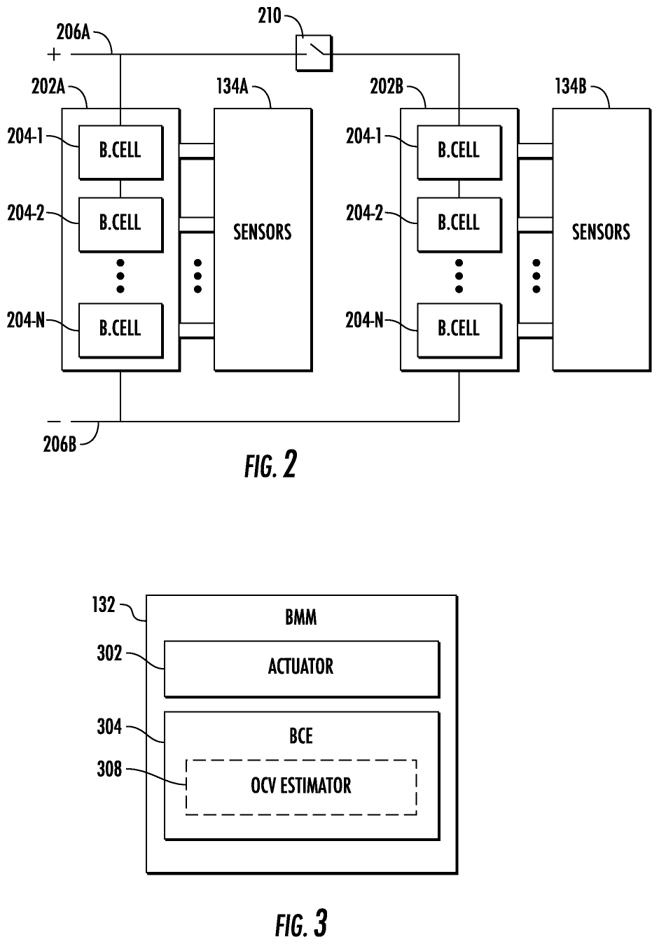

Referring to FIG. 3, in one form, the BMM 132 includes an actuator 302 for operating the contactors 210 in the closed/open positions and a battery characteristic estimator (BCE) 304. The BCE 304 is configured to estimate various operational characteristics of the battery pack 106, such as but not limited to, the OCV of each battery cell, the SOC of the battery pack 106, the power limit of the battery pack 106, and temperature of the battery pack 106. As described in detail here, the BCE 304 includes an OCV estimator 308 to estimate the OCV of each battery cell 204.

In a non-limiting example, during a driving/discharge of the battery pack 106, the BMM 132 is configured to provide one or more power limits in each direction, along with a minimum and maximum voltage limit to the control system 130. Among other considerations, the control system 130 considers a driver demand and takes the appropriate amount of power from the battery pack 106 (e.g., providing power to the battery pack 106 if regenerative braking power exceeds power from other loads). For HEVs (i.e., plug-in or non-plugin) and FCEVs, the control system 130 may also manage SOC to keep it in the desired range, charging the battery pack from the engine or fuel cell, as appropriate. In one form, the BMM 132 is configured to ensure that if the power level is followed, the voltage limit of the battery pack 106 is not exceeded.

In one form, the OCV estimator 308 is configured to estimate the OCV based on voltages measured by the sensors 134 after a previous/last deactivation of the EV 100 and a decay parameter that is a function of the voltages and a duration since the last deactivation. More specifically, equation 1 below is an algorithm employed by the BCE 304 to estimate the OCV for battery cell 204, where “V” is the voltage of the battery cell 204, “V_{OCV}” is the OCV, and “DP” is the decay parameter. Based on equation 1, the estimated OCVs represent a difference between the voltages and the decay parameters.

$$V = {V}_{ocv} + DP \qquad Equation 1$$

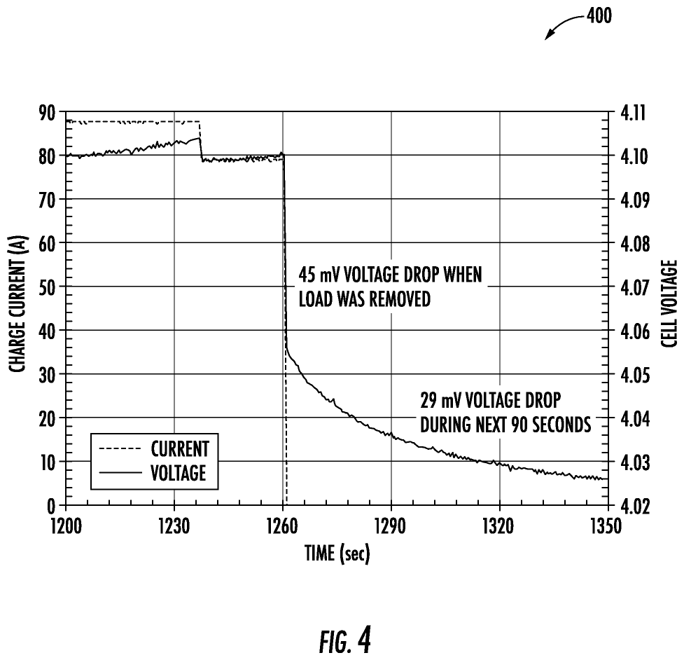

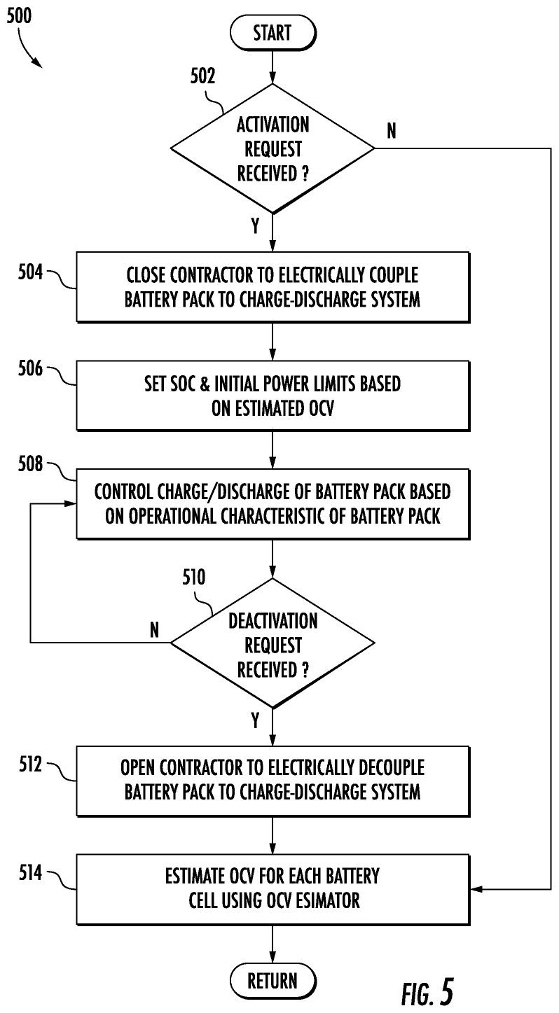

In one form, the decay parameter has a non-linear correlation with voltage in that, after deactivation, the voltage measurements of each battery cell 204 begins to decrease over time, and the change in voltage is not linear. For example, FIG. 4 illustrates an example graph 400 mapping the electrical characteristic (e.g., voltage and current) of a battery cell 204 over time, and at 1260 secs the battery pack 106 is decoupled from the charge-discharge system. As illustrated, the voltage begins to decay, non-linearly, over time.

The decay parameter of equation 1 characterizes the decaying voltage using an exponential parameter involving a square root of the duration, and further includes a coefficient and a constant that are a function of the voltages. More specifically, the decay parameter may be one of the following βe^{-\sqrt{kt}}, βe^{-k\sqrt{t}}, or βe^{-\sqrt{t/k}} in which “β” is a coefficient, “k” is a time constant, and “t” is time. The difference between the various decay parameters is the unit for the time constant. In addition, the sign of “β” is dependent on the direction of the current just before the battery pack 106 is decoupled. That is, if the battery pack 106 was being (predominately) discharged just before deactivation, the sign of β is negative indicating the voltage will be lower than the OCV. If the battery pack 106 was being (predominately) charged, β is positive.

In one form, the decay parameter is estimated for each battery cell based on the voltage measurements using known parameter estimation techniques such as, but not limited to, non-linear regression models. The decay parameter is learned when estimating the OCV because the time constant may change due to the phase change of the anode of the battery cell 204. After a defined period of time has lapsed, or the estimated decay parameter not changing by a selected threshold, the BCE 304 determines the OCV based on equation 1.

In some variations, the BCE 304 may be configured to employ a refined algorithm to estimate the OCV when the EV 100 operates under certain conditions. Specifically, when the environmental condition is very cold (e.g., lower than −20 deg.C) and/or the SOC low (e.g., 5%), a single exponential term may not accurately estimate the OSC due to the influence battery cells 204 may have on each other. Accordingly, the BCE 304 is configured to use equation 2, shown below, for estimating the OCV. In equation 2, DP1 is a first decay parameter and DP2 is a second decay parameter, where the first decay parameter and the second decay parameter have different coefficients and time constants. In a non-limiting example, the first decay parameter is provided as β₁e⁻\sqrt{k₁^{t}} and the second decay parameter is provided as β₂e⁻\sqrt{k₂^{t}}.

$$V = {V}_{ocv} + {β}_{1} {e}^{- \sqrt{{k}_{1} t}} + {β}_{2} {e}^{- \sqrt{{k}_{2} t}} \qquad Equation 2$$

Referring to FIG. 5, an example battery pack control routine 500 executed by the BMM 132 and the control system 130 (i.e., a vehicle controller) is provided and supported by the present disclosure. At 502, the BMM 132 determines if an activation request is received and, if received, the BMM 132 closes the contactors 210 to electrically couple the battery pack 106 to the charge-discharge system of the EV 100, at 504. At 506, the controller 132 sets a SOC and initial power limits using OCVs estimated after the last deactivation of the EV 100. At 508, the controller 132 controls charge/discharge of the battery pack 106 based on operational characteristics of the battery pack 106, which includes the power limit. Once activated, the SOC and power limits is updated using known techniques.

At 510, the controller 132 determines if the deactivation request is received. If it is not received, the controller 132 returns to 508 to control the battery pack 106. As known, values of one or more operational characteristics, such as the power limit and SOC, may be updated when the EV 100 is charging/discharging using predefined models/algorithms. Accordingly, the controller 132 may use updated characteristics to control the battery pack 106.

If the deactivation request is received, the controller 132 opens the contactors 210 to electrically decouple the battery pack 106 from the charge-discharge system of the EV 100 at 512. At 514, the controller estimates the OCV for each of the battery cells using the OCV estimator 308 as described above. From 514, the controller 132 determines if the activation request received, at 502. If it is not received, the controller 132 estimates the OCV for each battery cell 204. That is, the OCV may be estimated again if no activation request is received.

The battery pack control routine 500 may be configured to perform other operations within the scope of the present disclosure, and should not be limited to the example described herein. In a non-limiting example, the routine 500 may stop estimating the OCV if a predefined period of time has passed that is based on an estimated equilibrium time for the batter pack 106 and/or the previous OCVs vary from one another by a selected threshold.

In lieu of waiting for the battery cells 204 to stabilize to obtain the OCV, the BMM 132 of the present disclosure is configured to estimate the OCV for each battery cell with improved accuracy using the OCV estimator 308, and thus, improving accuracy of the power limit, the SOC, SOH, and other characteristics.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

In this application, the term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory or memory device is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An electrified vehicle (EV) comprising:
a battery pack including a plurality of battery cells and operable to provide at least a portion of propulsion power of the EV;
one or more sensors; and
a vehicle controller configured to charge and discharge the battery pack according to power limits defined at activation of the EV by an estimated open circuit voltage (OCV) for each of the battery cells that is based on voltages measured by the one or more sensors after a last deactivation of the EV and a decay parameter that is a function of the voltages and a duration since the last deactivation.

2. The EV of claim 1, wherein the decay parameter includes a coefficient that is a function of the voltages.

3. The EV of claim 1, wherein the decay parameter includes a constant that is a function of the voltages.

4. The EV of claim 1, wherein the decay parameter has a non-linear correlation with the voltages.

5. The EV of claim 1, wherein the decay parameter includes an exponential parameter involving a square root of the duration.

6. The EV of claim 1, wherein the vehicle controller is configured to detect the decay parameter using a non-linear regression model.

7. The EV of claim 1, wherein the vehicle controller is configured to estimate an initial state of charge of the battery pack based on the estimated OCV, wherein the power limits are defined, in part, by the initial state of charge.

8. The EV of claim 1, wherein the duration is less than an equilibrium time for active material of each of the battery cells to equally distribute across an electrode of the battery cell.

9. A method of controlling an electrified vehicle (EV) having a battery pack including a plurality of battery cells, comprising:
responsive to a deactivation request, opening one or more contactors to electrically decouple the battery pack from a charge-discharge system of the EV;
responsive to an activation,
closing the one or more contactors to electrically couple the battery pack to the charge-discharge system, and
charging or discharging the battery pack according to power limits defined at the activation of the EV by an estimated open circuit voltage (OCV) for each of the battery cells that is based on voltages measured by one or more sensors after a last deactivation of the EV and a decay parameter that is a function of the voltages and a duration since the last deactivation.

10. The method of claim 9, wherein the decay parameter includes a coefficient that is a function of the voltages.

11. The method of claim 9, wherein the decay parameter includes a constant that is a function of the voltages.

12. The method of claim 9, wherein the decay parameter has a non-linear correlation with the voltages.

13. The method of claim 9, wherein the decay parameter includes an exponential parameter involving a square root of the duration.

14. The method of claim 9, further comprising detecting the decay parameter using a non-linear regression model.

15. The method of claim 9, wherein the vehicle controller is configured to estimate an initial state of charge of the battery pack based on the estimated OCV, wherein the power limits are defined, in part, by the initial state of charge.

16. The method of claim 9, wherein the duration is less than an equilibrium time for active material of each of the battery cells to equally distribute across an electrode of the battery cell.

17. A system for an electrified vehicle (EV) including a battery pack having a plurality of battery cells and operable to provide at least a portion of propulsion power of the EV, the system comprising:
a controller configured to charge and discharge the battery pack according to a state of charge that is initially defined at activation of the EV by an initial state of charge that is based on an estimated open circuit voltage (OCV) for each of the battery cells, the OCV being based on voltages measured by one or more sensors of the EV after a last deactivation of the EV and a decay parameter that is a function of the voltages and a duration since the last deactivation, wherein the duration is less than an equilibrium time for active material of each of the battery cells to equally distribute across an electrode of the battery cell.

18. The system of claim 17, wherein the estimated OCVs represent a difference between the voltages and the decay parameters.

19. The system of claim 17, wherein the decay parameter includes a coefficient that is a function of the voltages.

20. The system of claim 17, wherein the decay parameter has a non-linear correlation with the voltages.
